(19) United States
(12) Patent Application Publication
(10) Pub. No.: US 2008/0273122 A1
(43) Pub. Date: Nov. 6, 2008

(54) RECEPTION SYSTEM

(76) Inventor: Hitoshi AZUMA, Tenri-shi (JP)

Correspondence Address: NIXON & VANDERHYE, PC, 901 NORTH GLEBE ROAD, 11TH FLOOR, ARLINGTON, VA, 22203, US

(21) Appl. No.: 11/940,726

(22) Filed: Nov. 15, 2007

(30) Foreign Application Priority Data
May 3, 2007 (JP) 2007-053736

(51) Int. Cl. H04N 5/50

(52) U.S. Cl. 348/731; 725/151; 348/725; 348/E05.003

(57) ABSTRACT

A reception system receiving the broadcast wave of a digital broadcast to acquire the video or audio signal of the broadcast has: a tuner circuit detecting the broadcast wave at a predetermined frequency to convert it into an intermediate-frequency signal; and a receiver device having a first terminal connected to the tuner circuit to receive the intermediate-frequency signal by way of the first terminal. The receiver device has, arranged on a single circuit board: a digital demodulation circuit portion receiving the intermediate-frequency signal to demodulate it; a digital circuit portion decompressing the signal demodulated by the digital demodulation circuit portion; a video/audio output circuit portion converting the digital video or audio signal decompressed by the digital circuit portion into an analog video or audio signal; and a power supply portion supplying electric power to the digital demodulation circuit portion, the digital circuit portion, and the video/audio output circuit portion. A chassis is provided so as to cover the digital demodulation circuit portion, the digital circuit portion, the video/audio output circuit portion, and the power supply portion but not to cover the first terminal. With this construction, it is possible to minimize the entry of noise into the tuner circuit without imposing restrictions on the layout of the different components for the processing of broadcast signals and that can diminish the fabrication cost of a video display device.

This nonprovisional application claims priority under 35 U.S.C. § 119(a) on Patent Application No. 2007-053736 filed in Japan on Mar. 5, 2007, the entire contents of which are hereby incorporated by reference.

### BACKGROUND OF THE INVENTION

1. Field of the Invention

The present invention relates to a reception system that receives a broadcast wave and performs predetermined processing on a broadcast signal.

2. Description of Related Art

A block circuit diagram of an example of a conventional reception system that receives a broadcast wave is shown in FIG. 5. The reception system 500 includes a receiver device 700 that incorporates a tuner circuit portion 701, to the input side of which is connected an antenna 600. The tuner circuit portion 701 outputs an intermediate-frequency signal, which is fed to a digital demodulation IC 802 provided in a digital circuit portion 801 incorporated in a video display device 800.

The digital demodulation IC 802 is connected to a video/audio processing IC 804 provided in a digital circuit portion 803, and the video/audio processing IC 804 is connected to a video/audio processing memory 805, to a program memory 806—where the control code of the receiver device is stored, to a display processing portion 808, and to an audio processing portion 809.

A power supply portion 807 supplies electric power to each of the tuner circuit portion 701, the digital demodulator IC 802, the video/audio processing IC 804, the video/audio processing memory 805, the program memory 806, the display processing portion 808, and the audio processing portion 809.

Next, the operation of the reception system 500 will be described briefly. A high-frequency signal received at the antenna 600 is fed to the tuner circuit portion 701 in the receiver device 700. In the tuner circuit portion 701, the high-frequency signal is detected at a predetermined frequency, and is converted into an intermediate-frequency signal. The intermediate-frequency signal is then fed to the digital demodulator IC 802 in the digital circuit portion 801 incorporated in the video display device 800, and is converted into compressed digital video and audio signals.

The compressed digital video and audio signals are then fed to the video/audio processing IC 804 in the digital circuit portion 803, and are converted, by use of the video/audio processing memory 805, into decompressed digital video and audio signals. The decompressed digital video and audio signals are then fed to the display processing portion 808 and the audio processing portion 809 respectively to reproduce video and audio. The related conventional ar is disclosed, for example, in JP-A-2000-068673 and JP-A-H11-341375.

Inconveniently, however, the conventional art described above has the following disadvantages. For one thing, preventing entry of noise into the tuner circuit portion 701 may impose restrictions on the layout (arrangement) of the components, such as the digital demodulator IC 802, the video/audio processing IC 804, the video/audio processing memory 805, the program memory 806, etc.

For another thing, in the video display device 800, measures need to be taken not only against the unnecessary emissions and noise from the display processing portion 808 and the audio processing portion 809 but also against the unnecessary emissions and noise from the digital demodulator IC 802, the video/audio processing IC 804, the video/audio processing memory 805, and the program memory 806. This requires that the video display device 800 be additionally provided with a shield or otherwise properly designed, and may lead to increased fabrication cost.

For yet another thing, in the video display device 800, measures also need to be taken not only against the heat dissipated from the display processing portion 808 and the audio processing portion 809 but also against the heat dissipated from the digital demodulator IC 802, the video/audio processing IC 804, the video/audio processing memory 805, and the program memory 806. This requires that the video display device 800 be given a larger circuit board area, and/or additionally provided with a heat sink, or otherwise properly designed, and may lead to increased fabrication cost.

### SUMMARY OF THE INVENTION

The present invention has been devised to overcome the inconveniences mentioned above, and it is an object of the present invention to provide a reception system that can minimize the entry of noise into the tuner circuit without imposing restrictions on the layout of the different components for the processing of broadcast signals and that can diminish the fabrication cost of a video display device.

To achieve the above object, according to one aspect of the present invention, a reception system that receives the broadcast wave of a digital broadcast to acquire the video or audio signal of the broadcast is provided with: a tuner circuit that detects the broadcast wave at a predetermined frequency to convert it into an intermediate-frequency signal; and a receiver device that has a first terminal connected to the tuner circuit to receive the intermediate-frequency signal by way of the first terminal. Here, the receiver device is provided with, arranged on a single circuit board: a digital demodulation circuit portion that receives the intermediate-frequency signal to demodulate it; a digital circuit portion that decompresses the signal demodulated by the digital demodulation circuit portion; a video/audio output circuit portion that converts the digital video or audio signal decompressed by the digital circuit portion into an analog video or audio signal; and a power supply portion that supplies electric power to the digital demodulation circuit portion, the digital circuit portion, and the video/audio output circuit portion. Moreover, a chassis is provided so as to cover the digital demodulation circuit portion, the digital circuit portion, the video/audio output circuit portion, and the power supply portion but not to cover the first terminal.

With this construction, in the receiver device, the different components for the processing of broadcast signals (more specifically, the digital demodulation circuit portion, the digital circuit portion, the video/audio output circuit portion, and the power supply portion) are arranged such that they are covered by a chassis. Thus, with the shielding effect by the chassis, it is possible to minimize the entry of noise into the tuner circuit without imposing restrictions on the arrangement of those components.

Moreover, since the different components for the processing of broadcast signals are provided in the receiver device, a video display device does not need to be provided with such components. Thus, in the video display device, it is possible to suppress an increase in fabrication cost that would arise if it were provided with such components. Since the first terminal is not covered by the chassis, the connection between the terminal and the tuner circuit is not obstructed by the chassis.

In the construction described above, on the circuit board may be arranged, in order of increasing distance from the first terminal, the digital demodulation circuit portion, the power supply portion, the digital circuit portion, and the video/audio output circuit portion.

In the receiver device, the broadcast signal obtained through the reception of a broadcast wave is normally led from the first terminal, then to the digital demodulation circuit portion, then to the digital circuit portion, and then to the video/audio output circuit portion. The above construction thus adopts a component arrangement that follows this flow of the broadcast signal, and thus allows the broadcast signal to be fed efficiently. Moreover, the arrangement of the power supply portion between the digital demodulation circuit portion and the digital circuit portion makes it easy to reduce the electromagnetic noise between them.

In the construction described above, the tuner circuit may be electrically connected to the chassis to use it as ground. With this construction, the use of the chassis as the ground of the tuner circuit eliminates the need to provide a separate component for grounding.

In the construction described above, the ground pattern on the circuit board and the chassis may be connected together with solder on only one side of the circuit board. More specifically, the solder may applied on the back side of the circuit board.

With this construction, in the fabrication of the receiver device, the ground pattern on the circuit board and the chassis can be soldered together without reversing the circuit board. This helps reduce the fabrication cost of the receiver device. Here, the “back” side of the circuit board is its side at which the distance from the circuit board surface to the lid (the part substantially parallel to the mount surface of the circuit board) of the chassis is smaller than at the opposite side.

In the construction described above, the solder may be applied at a plurality of spots. With this construction, the ground pattern on the circuit board and the chassis can be connected together at more spots than in a construction where they are soldered together at one spot. This helps reduce the impedance between them.

In the construction described above, the receiver device may be further provided with a second terminal by way of which the receiver device outputs the analog video or audio signal to outside, the circuit board may have a substantially rectangular mount surface, the first terminal may be arranged at a first edge of the mount surface, and the second terminal may be arranged at a second edge—one perpendicular to the first edge—of the mount surface so as to protrude perpendicularly from the second edge.

With this construction, for example as shown in FIGS. 4A and 4B, the second terminal can be either left straight or bent according to whether to connect the receiver device in an upright or flat-laid state to the mount target component. Moreover, the above-mentioned arrangement of the first and second terminals relative to each other prevents the first terminal from being obstructed by the mount target component irrespective of whether the receiver device is connected to it in an upright or flat-laid state. This makes it easy to connect the receiver device to the tuner circuit.

In the construction described above, a ground pattern on the circuit board and the chassis may be connected together with solder on only one side of the circuit board, and the second terminal may be fixed to the circuit board by being connected to it with solder on only said one side of the circuit board.

With this construction, both the soldering together of the ground pattern on the circuit board and the chassis and the soldering together of the second terminal and the circuit board is done on the same side of the circuit board. Thus, the two steps of soldering can be done almost simultaneously or continuously without reversing the circuit board. This helps reduce the fabrication cost of the receiver device.

### BRIEF DESCRIPTION OF THE DRAWINGS

These and other objects and features of the present invention will be apparent from the following detailed description of preferred embodiments thereof taken in conjunction with the accompanying drawings, in which:

FIG. 1 is a block diagram of a reception system embodying the present invention;

FIG. 2 is a diagram showing the construction on the front side of the reception system embodying the present invention;

FIG. 3 is a diagram showing the construction on the back side of the reception system embodying the present invention;

FIG. 4A is a diagram illustrating the receiver device in a state connected to a video display device;

FIG. 4B is a diagram illustrating the receiver device in another state connected to a video display device; and

FIG. 5 is a block diagram of a conventional reception system.

### DETAILED DESCRIPTION OF PREFERRED EMBODIMENTS

As one embodiment of the present invention, a reception system that receives a broadcast wave will be described below. The reception system receives the broadcast wave of a digital broadcast to acquire the video and audio signals representing the contents of the broadcast. The reception system may be capable of the broadcast wave of an analog broadcast as well as that of a digital broadcast.

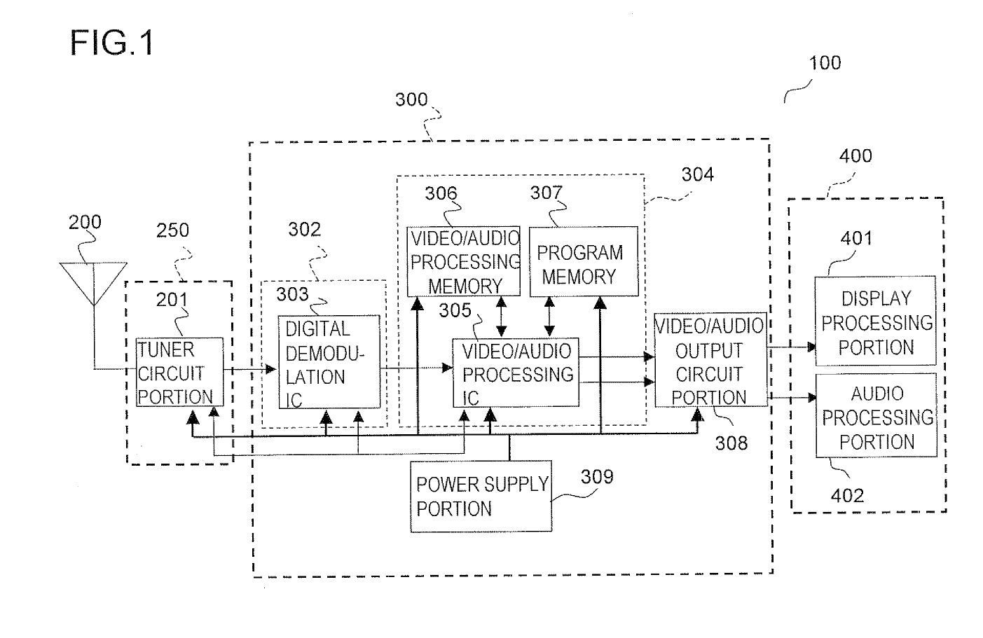

An outline of the configuration of the reception system is shown in FIG. 1. As shown there, the reception system 100 includes an antenna 200, a tuner device 250, a receiver device 300, a video display device 400, etc.

The tuner device 250 incorporates a tuner circuit portion 201 for tuning. As will be described later, the tuner device 250 also has, a tuner input terminal 502 to which a broadcast signal (high-frequency signal) is fed from the antenna 200; and a tuner output terminal 202 that is connected to a reception input terminal 503 of the receiver device 300 and by way of which an intermediate-frequency signal is fed to the receiver device.

The receiver device 300 incorporates, arranged on a single circuit board, a digital demodulation circuit portion 302, a digital circuit portion 304, a video/audio output circuit portion 308, a power supply portion 309, etc. The digital demodulation circuit portion 302 includes a digital demodulation IC 303. The digital circuit portion 304 includes a video/audio processing IC 305, a video/audio processing memory 306, and a program memory 307. The program memory 307 stores the control code of the receiver device. The video display device 400 includes a display processing portion 401, an audio processing portion 402, etc.

In the receiver device 300, the output side of the tuner circuit portion 201 is connected to the input side of the digital demodulation IC 303, and the output side of the digital demodulation IC 303 is connected to the input side of the video/audio processing IC 305. The video/audio processing memory 306 and the program memory 307, for storing the control code of the receiver device, are connected to the video/audio processing IC 305.

The tuner circuit portion 201 and the digital demodulation IC 303 are controlled by a serial control signal, which is fed to the video/audio processing IC 305. The power supply portion 309 is connected to each of the tuner circuit portion 201, the digital demodulation IC 303, the video/audio processing IC 305, the video/audio processing memory 306, the program memory 307, and the video/audio output circuit portion 308 to supply electric power to these components. The output side of the video/audio processing IC 305 is connected to the video/audio output circuit portion 308.

In the configuration described above, a broadcast signal received at the antenna 200 is fed to the tuner device 250 and then to the receiver device 300, and is meanwhile subjected to predetermined processing so as to be converted into the video and audio signal representing the contents of the broadcast. Then, based on these video and audio signals, video and audio are reproduced on the video display device 400. Described in more detail, the flow of the broadcast signal here is as follows.

The antenna 200 is connected to the tuner device 250 by a coaxial cable to feed it with the signal (high-frequency signal) of a broadcast wave. In the tuner device 250, the tuner circuit portion 201 detects the high-frequency signal at a predetermined frequency to convert it into an intermediate-frequency signal. The intermediate-frequency signal is then fed to the digital demodulation IC 303 in the digital demodulation circuit portion 302 so as to be demodulated. Obtained as the result of the demodulation here are compressed (for example, according to MPEG) digital video and audio signals.

The demodulated signals are fed to the video/audio processing IC 305 so as to be decompressed. Obtained as the result are normal (that is, decompressed) digital video and audio signals. The decompression here is done by use of various kinds of data stored in the video/audio processing memory 306 and the program memory 307.

The obtained digital video and audio signals are fed to the video/audio output circuit portion 308 to be converted into analog video and audio signals. These analog video and audio signals are fed to the video display device 400. In the video display device 400, the display processing portion 401 outputs video based on the video signal fed to it, and the audio processing portion 402 outputs audio based on the audio signal fed to it.

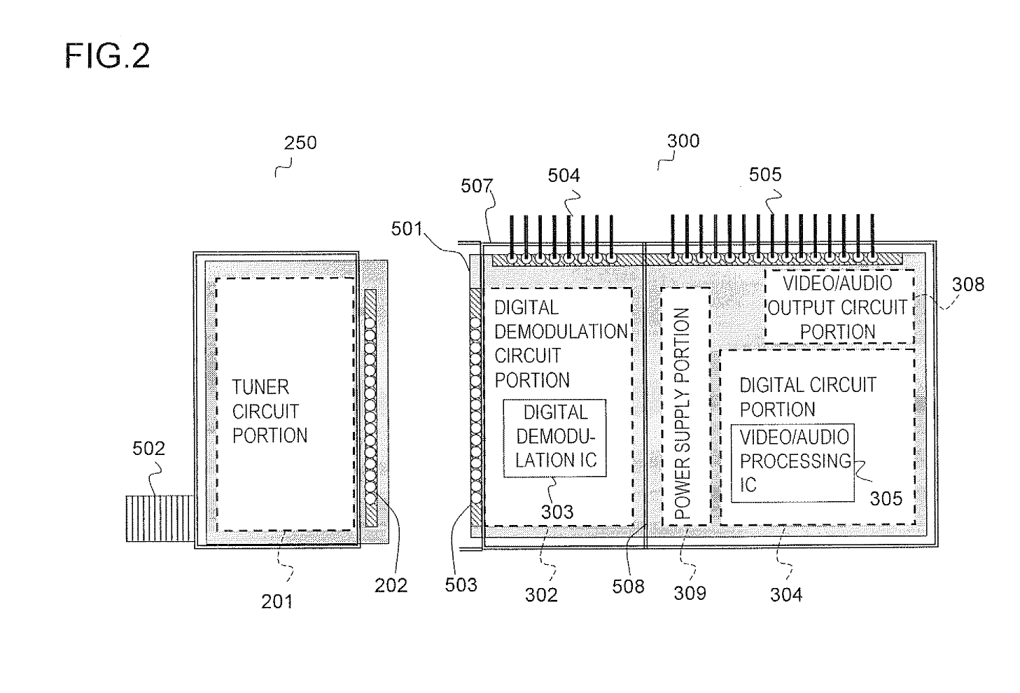

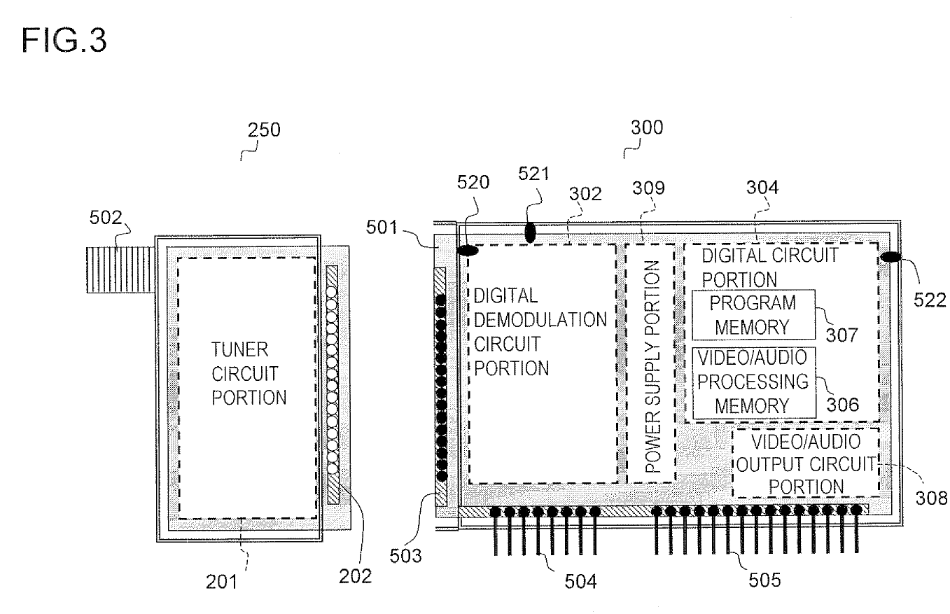

A practical construction of the receiver device 300 described above will now be described. FIGS. 2 and 3 are diagrams showing the construction of the tuner device 250 and the receiver device 300. FIG. 2 shows one side (front side) of the receiver device 300, and FIG. 3 shows the other side (back side) of the receiver device 300.

As shown in FIGS. 2 and 3, the receiver device 300 has its constituent circuits arranged on a single circuit board 501 having a rectangular mount surface. Along one edge of the circuit board 501 (in FIGS. 2 and 3, the left-hand edge), the reception input terminal 503 is provided. The reception input terminal 503 is connected to the tuner output terminal 202 so that the receiver device 300 and the tuner device 250 are electrically connected together, Thus, by way of these terminals, the broadcast signal outputted from the tuner device 250 is fed to the receiver device 300.

In practice, the tuner device 250 is typically one of devices that differ in specifications and performance from one shipment destination (country or region) to another. Thus, allowing the tuner device 250 to be externally attached to the receiver device 300 as in this reception system allows the receiver device to be shared, basically, with tuner devices that differ in specifications. This eliminates the need to prepare different receiver devices for tuners with different specifications, and thus helps minimize the fabrication cost of the reception system.

In the receiver device 300, the digital demodulation circuit portion 302, the power supply portion 309, the digital circuit portion 304, and the video/audio output circuit portion 308 are arranged in this order from left to right in FIGS. 2 and 3; that is, these components are arranged in the order just named in increasing order of distance from the reception input terminal 503,

This arrangement in the receiver device 300 follows the flow of the processing on the inputted broadcast signal (it flows from the digital demodulation circuit portion 302 to the digital circuit portion 304 and then to the video/audio output circuit portion 308), and thus ensures that the broadcast signal is fed efficiently. The power supply portion 309 is arranged between the digital demodulation circuit portion 302 and the digital circuit portion 304, and this makes it easy to reduce the electromagnetic noise between them.

The circuit board 501 is a multiple-layer circuit board. In the digital circuit portion 304, the video/audio processing IC 305, which is arranged on the front side of the circuit board 501, and the video/audio processing memory 306 and the program memory 307, which are arranged on the back side of the circuit board 501, are connected together by an interlayer conductor pattern.

In actual use, the circuit board 501 is almost entirely enclosed in (covered by) a metal chassis 507. The chassis 507 is box-shaped and large enough to house in it without an unnecessarily large margin the circuit board 501 and all the components arranged on it except for the reception input terminal 503, which is arranged outside the chassis 507.

More specifically, the shape (box-like shape) of the chassis 507 is formed as follows: lids that are substantially parallel to the circuit board 501 are provided one at the front side and the other at the back side of the circuit board, and side walls that connect the two lids together are provided along the edges of the circuit board 501. The distance from the circuit board 501 to the lid at the back side is smaller than the distance from the circuit board 501 to the lid at the front side.

Covered by the chassis 507 as described above, the components of the receiver device 300 are little affected by extraneous electromagnetic noise. On the other hand, arranged outside the chassis, the reception input terminal 503 allows easy connection to the tuner device 250, which is fitted externally.

On the back side of the circuit board 501, the circuit board 501 and the chassis 507 are connected together with solder at a plurality of spots (520 to 522 in FIG. 3). Thus, the digital ground pattern of the digital demodulation circuit portion 302 and that of the digital circuit portion 304 are connected to the chassis 507, achieving grounding by use of the metal, low-impedance chassis 507. The circuit board 501 and the chassis 507 may be soldered together at each of all edges of the circuit board 501.

In this way, the chassis 507 can be used not only to shield electromagnetic noise but also as ground for circuits. Soldering the circuit board 501 and the chassis 507 together at more spots helps connect them together at more spots, and thus helps reduce the impedance between them.

Soldering together on only one side of the circuit board 501 helps eliminate the need to reverse the circuit board 501 in the soldering step in fabrication. This helps reduce fabrication cost. Incidentally, soldering together on the back side of the circuit board 501 helps reduce the likeliness of the soldering device or tool making contact with the side walls of the chassis 507 in the soldering step, and thus helps enhance efficiency.

The ground pattern of the tuner circuit portion 201 may be connected to the chassis 507 of the receiver device 300 so that the chassis 507 is used as ground for the tuner circuit portion 201. In the receiver device 300, an additional shield plate 508, for example as shown in FIG. 2, may be arranged so that the parts located on opposite sides of the shield plate 508 are not affected by the electromagnetic noise from each other.

Along one edge of the circuit board 501, specifically an edge perpendicular to that along which the reception input terminal 503 is arranged (that is, an edge that forms a shape like the letter “L” with the one along which the reception input terminal 503 is arranged), first and second connector pins 504 and 505 for electrical connection to outside the receiver device 300 are arranged so as to protrude perpendicularly from the edge.

These connector pins serve as the input and output terminals of the digital demodulation circuit portion 302, the power supply portion 309, the digital circuit portion 304, and the video/audio output circuit portion 308. The second connector pins 505, in particular, serve to allow the analog video and audio signals to be outputted from the video/audio output circuit portion 308 to outside (to the video display device 400).

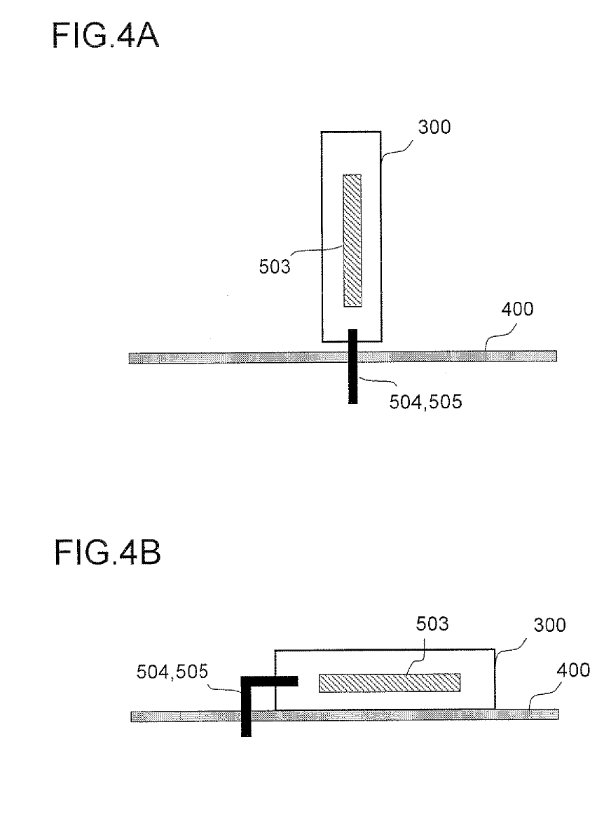

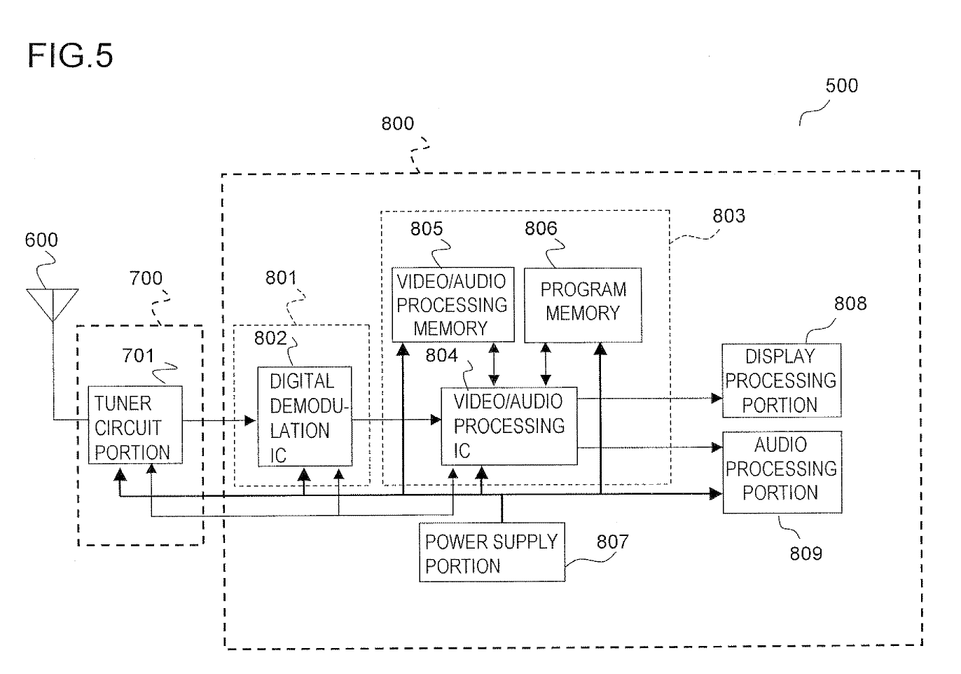

Now, how the receiver device 300 is connected to the video display device 400 will be described with reference to FIGS. 4A and 4B. FIG. 4A shows the receiver device 300 connected to the video display device 400 with the former in an upright state relative to the latter, and FIG. 4B shows the receiver device 300 connected to the video display device 400 with the former in a flat-laid state relative to the latter.

As shown in FIGS. 4A and 4B, when the receiver device 300 is connected in an upright state to the video display device 400, the connector pins 504 and 505 naturally make contact with the video display device 400, thereby achieving electrical connection between the receiver device 300 and the video display device 400.

By contrast, when the receiver device 300 is connected in a flat-laid state to the video display device 400, the connector pins 504 and 505 are bent at right angles to make contact with the video display device 400, their being so bent achieving electrical connection between the receiver device 300 and the video display device 400.

Thus, irrespective of whether the receiver device 300 is connected in an upright or flat-laid state to the video display device 400, the connector pins 504 and 505 can easily be brought into contact with the video display device 400 to achieve electrical connection between the receiver device 300 and the video display device 400. In either case, the reception input terminal 503 does not make contact with the video display device 400, and thus its connection to the tuner circuit portion 201 is not obstructed.

The connector pins 504 and 505 are fixed to the circuit board 501 by being connected to it with solder. The soldering here is done on the back side of the circuit board 501. Thus, their soldering can be done almost simultaneously or continuously without reversing the circuit board, and this helps reduce the fabrication cost of the receiver device.

It should be understood that the present invention may be practiced otherwise than specifically described by way of an embodiment above and that many variations and modifications are possible within the spirit of the invention.

According to the reception system described above, in the receiver device, the different components (more specifically, the digital demodulation circuit portion, the digital circuit portion, the video/audio output circuit portion, and the power supply portion) for the processing of broadcast signals are arranged so as to be covered by the chassis. Thus, with the shielding effect by the chassis, it is possible to minimize the entry of noise into the tuner circuit without imposing restrictions on the arrangement of those components.

Moreover, since the different components for the processing of broadcast signals are provided in the receiver device, a video display device does not need to be provided with such components. Thus, in the video display device, it is possible to suppress an increase in fabrication cost that would arise if it were provided with such components. Since the first terminal is not covered by the chassis, however, the connection between the terminal and the tuner circuit is not obstructed by the chassis.

What is claimed is:

1. A reception system receiving a broadcast wave of a digital broadcast to acquire a video or audio signal of the broadcast, comprising:
a tuner circuit detecting the broadcast wave at a predetermined frequency to convert the broadcast wave into an intermediate-frequency signal; and
a receiver device having a first terminal connected to the tuner circuit, the receiver device receiving the intermediate-frequency signal by way of the first terminal;
wherein
the receiver device comprises, arranged on a single circuit board:
a digital demodulation circuit portion receiving the intermediate-frequency signal to demodulate the intermediate-frequency signal;
a digital circuit portion decompressing a signal demodulated by the digital demodulation circuit portion;
a video/audio output circuit portion converting a digital video or audio signal decompressed by the digital circuit portion into an analog video or audio signal; and
a power supply portion supplying electric power to the digital demodulation circuit portion, the digital circuit portion, and the video/audio output circuit portion, and
a chassis is provided so as to cover the digital demodulation circuit portion, the digital circuit portion, the video/audio output circuit portion, and the power supply portion but not to cover the first terminal.

2. The reception system according to claim 1,
wherein on the circuit board are arranged, in order of increasing distance from the first terminal, the digital demodulation circuit portion, the power supply portion, the digital circuit portion, and the video/audio output circuit portion.

3. The reception system according to claim 1,
wherein the tuner circuit is electrically connected to the chassis to use the chassis as ground.

4. The reception system according to claim 1,
wherein a ground pattern on the circuit board and the chassis are connected together with solder on only one side of the circuit board.

5. The reception system according to claim 4,
wherein the solder is applied on a back side of the circuit board.

6. The reception system according to claim 4,
wherein the solder is applied at a plurality of spots.

7. The reception system according to claim 1, wherein
the receiver device further comprises a second terminal by way of which the receiver device outputs the analog video or audio signal to outside,
the circuit board has a substantially rectangular mount surface,
the first terminal is arranged at a first edge of the mount surface, and
the second terminal is arranged at a second edge of the mount surface so as to protrude perpendicularly from the second edge, the second edge being perpendicular to the first edge.

8. The reception system according to claim 7, wherein
a ground pattern on the circuit board and the chassis are connected together with solder on only one side of the circuit board, and
the second terminal is fixed to the circuit board by being connected thereto with solder on only said one side of the circuit board.
